(19) United States
(12) Patent Application Publication
(10) Pub. No.: US 2006/0086071 A1
(43) Pub. Date: Apr. 27, 2006

(54) Dust filter washing system

(76) Inventor: Aurelio Messina, Cusano, Milanino (MI) (IT)

Correspondence Address: WILLIAM COLLARD;COLLARD & ROE, P.C., 1077 NORTHERN BOULEVARD, ROSLYN, NY, 11576, US

(21) Appl. No.: 11/254,429

(22) Filed: Oct. 20, 2005

(30) Foreign Application Priority Data
Oct. 22, 2004 (IT) MI2004A002014
Mar. 23, 2005 (IT) MI2005U000095

(51) Int. Cl. B01D 46/04

(52) U.S. Cl. 55/302

(57) ABSTRACT

A dust filter washing system containing a compressed air tank connected to a bearing tube, which in turn is connected to an ejector tube. There is a piston ejector valve that is mounted on this bearing tube. The ejector valve contains at one end a sealing base connected to a piston by means of a return spring, the piston slides in the ejector valve, wherein the ejector valve further contains a locking nut at the other end.

### CROSS REFERENCE TO RELATED APPLICATIONS

Applicant claims priority under 35 U.S.C. §119 of Italian Application Nos. M1 2004 A002014 and M1 2005 U000095, filed Oct. 22, 2004 and Mar. 23, 2005, respectively the disclosures of which are hereby incorporated herein by reference.

### BACKGROUND OF THE INVENTION

This invention relates to a dust filter washing system using a new piston valve system with a new ejector tube blocking system.

FIG. 1 shows the prior art which shows a known system for washing filters.

For the maintenance of filters 102, such as cloth sleeve, pocket or cartridge filters, these filters can be connected to by suction systems 101, to trap or hold dirt or other particles.

The known dust filter washing system contains a bearing tube, which in turn is connected to an ejector tube for the emission of air jets 103 to the filter elements 102.

The compressed air 103 comes from a tank 104 connected to the air distribution system, on which diaphragm ejector valves 105 are mounted (with either electric or pneumatic control). These valves 105 are usually connected to the ejector tube which is placed inside the filter via a flange connector 106.

Such washing systems are generally activated by an automatic control generated as a result of a predetermined degree of clogging of the filter or, alternatively, according to an activation cycle which is preset or on a direct command of an operator.

Upon activation of the washing system, the compressed air jets 103 generated by means of the compressed air tank 104, following action of the ejector valves 105, are injected into the filter element 102. This results in precipitation of the particles trapped in an underlying bin.

The diaphragm ejector valves 105, used in the known dust filter washing systems have the disadvantage of being particularly cumbersome and delicate, therefore requiring time-scheduled maintenance.

Furthermore, such diaphragm valves require mounting on the compressed air tank at a pitch pre-established from time to time and in the necessary number, so that it is not possible to mount them at close pitches.

In addition, the coupling necessary to connect such diaphragm valves to the ejector tube constitutes a rather complicated and costly solution.

### SUMMARY OF THE INVENTION

The invention can be designed to eliminate the disadvantages in the known types of dust filter washing systems by using a dust filter washing system which uses valves that can be mounted on a compressed air tank with close pitches and that are not subject to heavy wear.

This design can make a dust filter washing system which, at equal air capacity, uses valves of reduced size.

This design can make a dust filter washing system that can be easily produced at competitive costs.

This design can make a dust filter washing system that is constantly reliable in operation and particularly efficient.

This task and these and other objects, which will be more evident from the description of the invention, are accomplished by the dust filter washing system that contains a compressed air tank connected to a bearing tube, which is in turn connected to an ejector tube, and has a piston ejector valve that is mounted on the bearing tube. This ejector valve has at one end a sealing base connected to a piston via a return spring. The piston slides in the ejector valve, wherein the ejector valve further contains at the other end, a locking nut.

This piston, the locking nut and the sealing base each have a toroidal gasket extending up to the bearing tube.

### BRIEF DESCRIPTION OF DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a side view of the prior art;

FIG. 2 is a side view partially in section of a first embodiment of the dust filter washing system; and

FIG. 3 is a side view partially in section of a second embodiment of the dust filter washing system.

### DETAILED DESCRIPTION

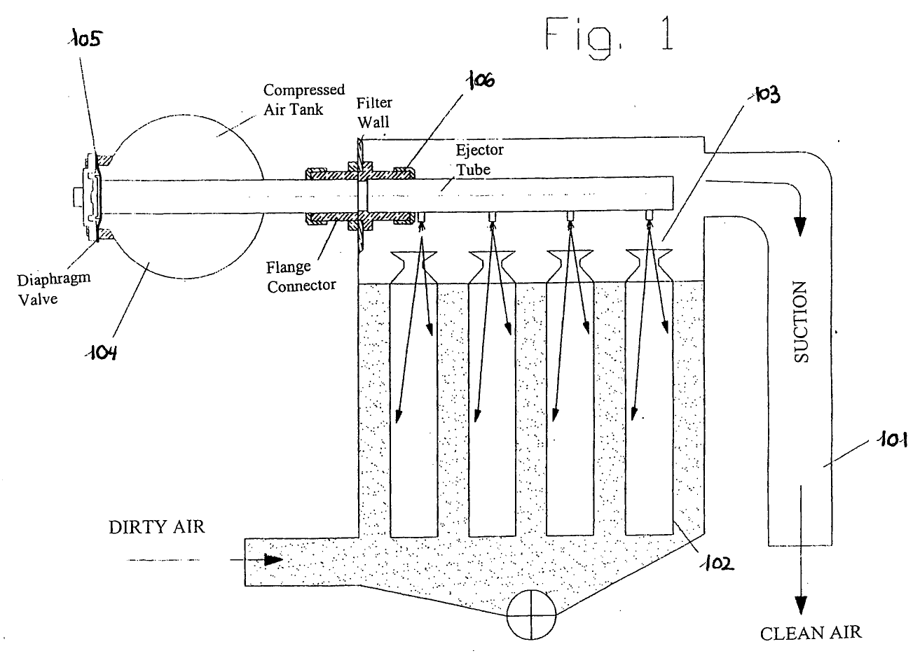

FIG. 1 is a side view of the prior art.

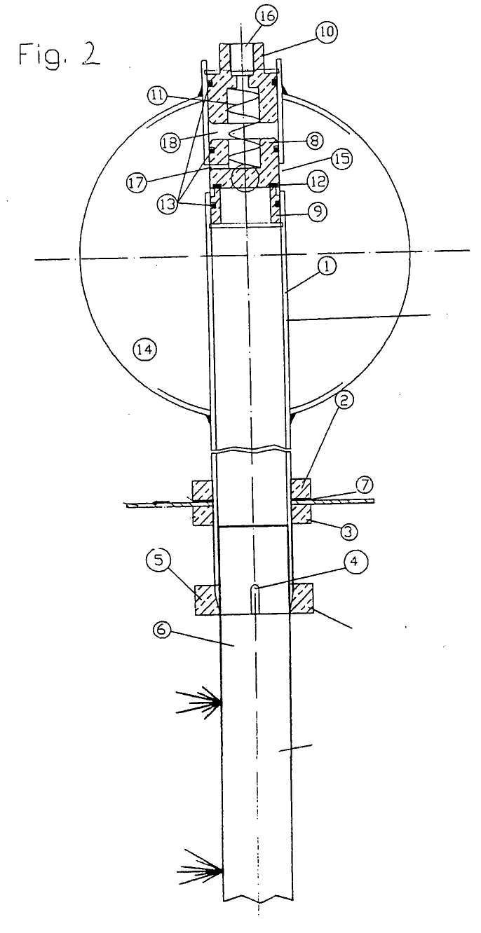

FIG. 2, shows an example of the invention that can include a dust filter washing system which contains a compressed air tank 14 connected to or in communication with a bearing tube 1, which in turn, is connected to an ejector tube 6 for the emission of air jets to filter elements (not shown). Examples of these types of filter elements are shown in FIG. 1.

The bearing tube 1 is transversely welded to tank 14 and is fastened to the filter elements by means of the action of a nut 2, a counternut 3 and a locking gasket 7.

Furthermore, the end of bearing tube 1, inside the filter element, is threaded and milled, so that a conical nut 5 supporting and blocking ejector tube 6 can be mounted. This conical nut completely substitutes for the very expensive flange connector 106 of the state of the art which is shown, for example, in FIG. 1.

The passage of air from tank 14 to ejector tube 6 is regulated by a piston ejector valve that contains, on one side, a locking nut 9 and on the other side, a sealing base 10, between which a piston 8 has a locking gasket 12 that can slide, acting against the force of a return spring 11.

Furthermore, each of the elements 8, 9 and 10 presents a toroidal gasket 13 extending up to bearing tube 1.

With the system off, that is, when passage 16 in sealing base 10 is closed, chamber 18 is connected to and in communication with compressed air tank 14 through hole 17 provided in piston 8, so that piston 8 remains in position, as shown. Piston 8 blocks the connection between compressed air tank 14 and bearing tube 1. This ejector tube 6 is in turn connected to bearing tube 1.

The system is therefore activated by opening passage 16 in sealing base 10. By doing this, the pressure in chamber 18 is cancelled and the return spring attracts piston 8 toward sealing base 10, thereby opening passage 15 and enabling the compressed air to pass from tank 14 to ejector tube 6.

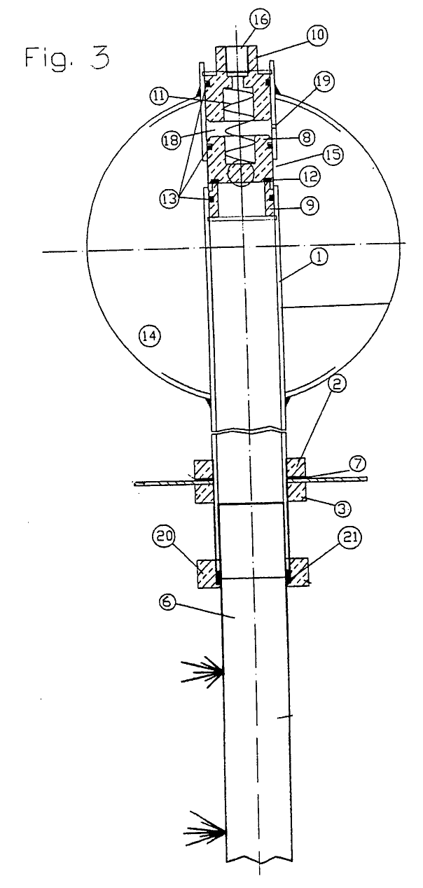

FIG. 3 shows a second embodiment of the dust filter washing system. The dust filter washing system of FIG. 3 also includes a piston ejector valve, which in turn contains a piston 8 that can be moved between a locking nut 9 and a sealing base 10 via of the action of a return spring 11. In this case too, each of the elements 8, 9 and 10 has a toroidal gasket 13 extending up to bearing tube 1.

Also in the piston ejector valve of the second embodiment of the washing system, there is a hole 19, which connects tank 14 to chamber 18. In contrast to the piston ejector valve of the first embodiment, this hole is not in piston 8 itself, but is made in bearing tube 1.

With the system off, that is, when passage 16 in sealing base 10 is closed, piston 8 is maintained in the position blocking passage 15, connecting tank 14 with ejector tube 6 for the compressed air present in chamber 18.

In this case too, when the system is activated by opening passage 16, the pressure in chamber 18 is cancelled. At this point, the pressure in tank 14 acts on the bottom of piston 8, which is quickly raised. Passage 15 is thereby opened and the compressed air in tank 14 passes to ejector tube 6.

When passage 16 is reclosed, hole 19 guarantees that the compressed air tank 14 will again refill chamber 18 with compressed air, thus pushing piston 8 toward locking nut 9 and closing passage 15 of compressed air to ejector tube 6.

In the washing system shown in FIG. 3, the system blocking the ejector tube is made up of a cylindrical nut 20 and a segment of elastic material, such as plastic or rubber 21.

Cylindrical nut 20 exerts a pressure on segment 21 which, slightly deformed, blocks ejector tube 6.

This design is advantageous as compared to the device in FIG. 1, since millings 4 of the back end of bearing tube 1 can be avoided, further simplifying the manufacturing process of the system.

Furthermore, plastic or rubber element 21 performs a pneumatic locking function between bearing tube 1 and ejector tube 6, guaranteeing a high pressure of the air jets used for washing the filters.

It has been proven, in practice, that the dust filter washing system as shown in FIGS. 2 and 3 is mechanically simpler and faster in working, thus reducing the production costs of the system.

Furthermore, the ejector valve used in the washing system as shown in FIGS. 1 and 2 does not have wear points that require scheduled maintenance. In addition, such piston ejector valves take up space, at equal air capacity, less than 50% that of diaphragm valves.

Finally, these piston ejector valves make it possible to mount them on the tank at close pitches.

This invention so designed is capable of numerous modifications and variations, all coming within the concept of the invention. Thus, for example, the materials used as well as the dimensions may be any at all, depending on requirements.

Therefore, the scope of protection of the claims should not be limited by the illustrations or by the preferred embodiments illustrated in the description in the form of examples, but rather the claims should embrace all of the patentable characteristics of novelty of this invention, including all the characteristics that will be treated as equivalents by the technical expert.

1. A dust filter washing system comprising:
a) a compressed air tank;
b) a bearing tube coupled to said compressed air tank;
c) an ejector tube coupled to said bearing tube;
d) a piston ejector valve coupled to said bearing tube;
e) a sealing base coupled to said ejector valve;
f) a piston coupled to said sealing base, and slidable onto said ejector valve;
g) a return spring coupled to said piston; and
h) a locking nut coupled to said piston ejector valve wherein said piston ejector valve controls air flow between said compressed air tank and said ejector tube.

2. The dust filter washing system as in claim 1, wherein said piston, said locking nut and said sealing base each have a toroidal gasket up extending to said bearing tube.

3. The dust filter washing system as in claim 1, further comprising a nut, a counter nut, and a flat locking gasket, coupled to said bearing tube at its end distant from said tank.

4. The dust filter washing system as in claim 1, wherein said tank is directly connected to, and in fluid communication with said chamber formed between said piston and said sealing base by means of a hole disposed in said piston.

5. The dust filter washing system as in claim 1, further comprising a chamber wherein said tank is directly connected to said chamber formed between said piston and said sealing base via a hole made in the bearing tube.

6. The dust filter washing system as in claim 1, wherein said bearing tube has an end that is threaded and milled disposed opposite its end distant from said compressed air tank.

7. The dust filter washing system as in claim 6, further comprising a conical nut, wherein said ejector tube is connected to said bearing tube via said conical nut.

8. The dust filter washing system as in claim 1, further comprising a cylindrical nut, wherein said bearing tube is connected to said ejector tube via said cylindrical nut, screwed on at an end distant from said compressed air tank of said bearing tube, the system further comprising an elastic element which is inserted between said cylindrical nut and said bearing tube.

9. The dust filter washing system as in claim 1, wherein said piston has a locking nut.
